(19) United States
(12) Patent Application Publication
(10) Pub. No.: US 2023/0153907 A1
(43) Pub. Date: May 18, 2023

(54) SYSTEM AND METHOD FOR IN-GAME OR IN-APPLICATION CARBON FOOTPRINT OFFSETTING VIA RENEWABLE ENERGY CERTIFICATE, OR SIMILAR INSTRUMENT, MANAGEMENT

(71) Applicant: Renew-Able, LLC, Leander, TX (US)

(72) Inventors: Dwynne Igau, Leander, TX (US); Richard C. Igau, Leander, TX (US); Justin Posey, Leander, TX (US)

(21) Appl. No.: 18/054,436

(22) Filed: Nov. 10, 2022

Related U.S. Application Data
(60) Provisional application No. 63/277,977, filed on Nov. 10, 2021.

(51) Int. Cl. G06Q 40/04; G06Q 30/02; G06Q 30/00

(52) U.S. Cl. CPC G06Q 40/04; G06Q 30/018; G06Q 30/0209

(57) ABSTRACT

A method is disclosed for renewable energy certificate exchange using a management system. An energy intelligence platform may include a computing device configured to receive and send requests from the management system and with different Renewable Energy Certificate (REC) exchanges. The energy intelligence platform can score, rank, and prepare purchase requests by including a level of RECs for a user’s location and the platform’s location, historical purchases, or renewable generation by location. The purchasing price can be calculated and a purchase made in the name of the user, gaming management system, ecommerce system or platform. RECs may be saved or retired to confirm the completed REC life-cycle from the energy intelligence platform to the management system or user. A virtual token prepared by the management system or the platform can be provided that reflects the renewable energy certificate purchase and controls an aspect of an application.

### CROSS-REFERENCES TO RELATED APPLICATIONS

This application claims priority to U.S. Provisional Pat. Application Serial No. 63/277,977 filed Nov. 10, 2021, titled “SYSTEM AND METHOD FOR IN-GAME OR IN-APPLICATION CARBON FOOTPRINT OFFSETTING VIA RENEWABLE ENERGY CERTIFICATE, OR SIMILAR INSTRUMENT, MANAGEMENT,” the entire disclosure of which is hereby incorporated by reference for all purposes.

### TECHNICAL FIELD

The present disclosure relates to management of information between multiple points. More particularly, and not by way of limitation, the present disclosure is directed to a system and method for the management of renewable energy certificates, credits, or similar instruments (e.g., forestation certificate, recycling certificate, a green or carbon-capture certificate, etc.) used for the purpose of carbon footprint offsetting, among other things.

### BACKGROUND

As preference and reliance on electronics rises, so too does electricity usage, calling for additional energy generation to meet the rising demand. Similarly, there is an increase in calls for renewable energy production and efforts to offset the costs of creating these new renewable generation locations. Renewable energy certificates (RECs) allow for the offsetting of non-renewable energy production, allowing a purchasing party to offset their carbon emissions by purchasing of the environmental attributes of renewable energy production. These purchases can be difficult and are often harder still to properly document.

### BRIEF SUMMARY

The present disclosure is related to a method for renewable energy certificate management with gaming, ecommerce, and/or wagering management systems. A purchase request can be received from one of the management systems by an energy intelligence platform that processes the purchase request. A value can be assigned to the purchase request for an individual user, as well as the management system, and those values then utilized to purchase renewable energy certificates, or similar carbon-offsetting instruments, in the name of the user and/or management system. The energy intelligence platform can perform communications that allow for the retiring of the renewable energy certificate, which can then be confirmed to the management system. Retiring the REC may refer to the user retaining ownership such that it can no longer be sold to another user (e.g., it is removed from circulation). A virtual token or other reward can be generated in consideration for the purchase amount, and the virtual token or other reward can then be provided to the user and/or management system.

Thus, in one aspect, the present disclosure is directed to methods for management and exchange of renewable energy certificates with an ecommerce system. An ecommerce system may include the ability to purchase renewable energy certificates as part of a goal to reduce carbon emissions and support renewable energy. The purchase request can be sent to an energy intelligence platform that receives the request from the ecommerce system. The energy intelligence platform can process the purchase request and calculate the required number of RECs required to facilitate the carbon offset for the purchase request. The RECs can then be purchased from the REC market in the name of a user and/or the ecommerce system. The purchased RECs can be saved and/or retired. A virtual token (e.g., reward, award, etc.) may be generated by the energy intelligence platform or the ecommerce system and may provide a benefit and/or advantage to the ecommerce system user.

In another aspect, the present disclosure is directed to a system for management of renewable energy certificate exchange with various gaming management systems. An energy intelligence platform can receive a renewable energy certificate purchase request from a gaming management system indicating it is for specific offsetting instruments associated with a virtual token. The energy intelligence platform can score the request, thus generating a carbon offset score (COS), whereby said score may be composite in nature. The COS may be comprised of any number of factors including but not limited to user locale, gaming management system locale, historical purchases, and regional energy generation sources. The COS can then be provided to the gaming management system. The energy intelligence platform can select the vendor and complete the REC and/or similar instrument purchase in the name of the user and/or gaming management system. The energy intelligence platform may then complete a retirement operation. The energy intelligence platform may prepare a virtual token that can be sent to the gaming management system or the gaming management system may prepare a virtual token autonomously. The virtual token may be configurable by a user of the gaming management system. The virtual token’s attributes may be modified such that one or more functionalities of the virtual token modify gameplay of a video game session, for example. Further, the virtual token’s attributes may be configured with a carbon offset footprint of one or more users.

### NOTATION AND NOMENCLATURE

Various terms are used to refer to particular system components. Different entities may refer to a component by different names - this document does not intend to distinguish between components that differ in name but not function. In the following discussion and in the claims, the terms “including” and “comprising” are used in an open-ended fashion, and thus should be interpreted to mean “including, but not limited to....” Also, the term “couple” or “couples” is intended to mean either an indirect or direct connection. Thus, if a first device couples to a second device, that connection may be through a direct connection or through an indirect connection via other devices and connections.

The terminology used herein is for the purpose of describing particular example embodiments only, and is not intended to be limiting. As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer or section from another region, layer or section. Terms such as “first,” “second,” and other numerical terms, when used herein, do not imply a sequence or order unless clearly indicated by the context. Thus, a first element, component, region, layer or section discussed below could be termed a second element, component, region, layer or section without departing from the teachings of the example embodiments. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Moreover, various functions described below can be implemented or supported by one or more computer programs, each of which is formed from computer readable program code and embodied in a computer readable medium. The terms “application”, “platform”, and “program” refer to one or more computer programs, computing systems acting as a cohesive unit, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), solid state drives (SSDs), NVMe, flash memory, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a detailed description of example embodiments, reference will now be made to the accompanying drawings in which:

FIG. 1 illustrates a system architecture according to certain embodiments of this disclosure.

FIG. 2A illustrates a high-level component diagram using the energy intelligence platform according to certain embodiments of this disclosure.

FIG. 2B illustrates various energy consuming computing devices according to certain embodiments of this disclosure.

FIG. 3 illustrates a power infrastructure.

FIG. 4 illustrates a Renewable Energy Credit (REC) exchange according to certain embodiments of this disclosure.

FIG. 5A illustrates an example Renewable Energy Credit (REC) management system according to certain embodiments of this disclosure.

FIG. 5B illustrates another example Renewable Energy Credit (REC) management system according to certain embodiments of this disclosure.

FIG. 6A illustrates an operational flow of interactions with an energy intelligence platform according to certain embodiments of this disclosure.

FIG. 6B illustrates an operational flow of interactions with an energy intelligence platform according to certain embodiments of this disclosure.

FIG. 7 illustrates an asynchronous operational flow of interactions with an energy intelligence platform according to certain embodiments of this disclosure.

FIG. 8 illustrates a hybrid operational flow of interactions with an energy intelligence platform according to certain embodiments of this disclosure.

FIG. 9 illustrates a synchronous operational flow of interactions with an energy intelligence platform according to certain embodiments of this disclosure.

FIG. 10 illustrates an example of a method for a gaming management system according to certain embodiments of this disclosure.

FIG. 11 illustrates an example of a method for an energy intelligence platform according to certain embodiments of this disclosure.

FIG. 12 illustrates an example computer system according to embodiments of this disclosure.

### DETAILED DESCRIPTION

It would be advantageous to have a system and method for offsetting instrument purchasing and management that overcomes the disadvantages of conventional techniques. The present disclosure provides such a system and method, among other things.

Renewable energy is the fastest growing form of energy production and is expected to surpass fossil fuels and conventional energy production in the years to come. As electrical energy is generated and transmitted to the wholesale power grid, the renewable benefits of energy generated by wind or solar sources are not distinguishable on an electron-by-electron basis from the power electrons generated by non-renewable fossil-fueled energy sources; to deal with this fact and facilitate a commercial carbon footprint offset marketplace, Renewable Energy Certificates (RECs) have been established in most global power markets. RECs are distinct from the energy created and supplied to the grid. RECs embody environmental attributes of energy generated by wind and/or solar energy generating projects. RECs are offsetting instruments issued by a respective power grid Independent System Operator or Regional Transmission Operator in the generator’s region. A company or individual can purchase RECs to offset their greenhouse or carbon emissions arising from non-renewable electrical power generation. Utilizing RECs to provide carbon offsets for electrical energy use is a well-established means of “greening” or making energy use environmentally sustainable. RECs are commonly used to offset standard energy use on a one-for-one basis, one megawatt of energy use for one REC. RECs are market-based instruments that certify the bearer owns one megawatt-hour (MWh) of electricity generated from a renewable energy resource. RECs are sold after the power provider has fed the energy produced into the power grid. RECs account for the amount of renewable energy flowing through a power grid.

RECs can be purchased on behalf of end users (commercial, industrial, or individuals) through either electronic bulletin board, exchange systems or through bilateral agreements direct with the renewable generation ownership. The use of RECs is widely known or adopted by most retail power marketers and utilities, and even to more sophisticated commercial businesses, but RECs are not not widely known by most power consumers. In some embodiments, the present disclosure may provide a technical solution to address the need for an incentive system to attract more consumers to the REC market. Two such areas that may be addressed with the present disclosure may include gaming management systems, as well as retail commerce solutions (e.g., ecommerce management systems).

One example of how the present disclosure may work: a consumer (e.g., a user playing a video game referred to as a “gamer”) engaged in a gaming management system decides to purchase an add-on (e.g., in-game feature, such as a “skin” or a virtual item) or other in-game purchase, and the consumer is provided an option to buy a virtual token that is made “green” by assigning environmental attributes (e.g., REC or similar offsetting instrument). When this option is selected, a request is made from the gaming management system to the energy intelligence platform of the present disclosure. The energy intelligence platform may complete the REC purchase and confirm it with the gaming management system, which then provides the gamer with a “green” gaming element or virtual token that simultaneously represents (a) a carbon offsetting of the gamer’s power use and (b) direct support for renewable energy projects through a verifiable mechanism. The virtual token may also be configured to provide a certain functional feature and/or ornamental feature that modifies a characteristic or functionality of the virtual token when deployed in a video game session.

In some embodiments, the virtual token purchased by the user may be shared with one or more social media platforms (e.g., Facebook®, Twitter®, Instagram®, etc.) via one or more application programming interfaces. The virtual token may be associated with an account of the user on one or more social media platforms. Further, the virtual token may be presented on the user’s profile screen in one or more social media platforms. In some embodiments, information pertaining to the virtual token and/or RECs owned by the user may be presented for the user.

In some embodiments, the energy consumed by one or more users may be monitored on their energy consuming devices. For example, a software agent application may be installed on their energy consuming devices that tracks an amount of energy used by the energy consuming devices while charging. The energy consumption data may be transmitted to the energy intelligence platform that may use the energy consumption data to determine an average user’s carbon offset footprint. In some embodiments, the energy intelligence platform may determine each individual user’s carbon offset footprint. The carbon offset footprint may be used to determine a purchase price of the virtual token and a number of RECs to purchase to offset the user’s carbon footprint.

In some embodiments, an offsetting instrument portal may be presented on a computing device of the user. The offsetting instrument portal may present one or more graphical elements associated with the virtual token owned by the user, offsetting instruments owned by the user, or both. For example, if the user owns six RECs associated with solar energy, six solar panel graphical elements may be presented for the user’s account on a screen. Further, gamification may be used to further incentivize users to purchase more offsetting instruments. That is, various rewards may be assigned to the users when they achieve a threshold level of their carbon offset footprint. The reward may be a graphical element (e.g., a virtual trophy) that is presented on a screen associated with their user profile and/or account. The energy intelligence platform may generate and provide the offsetting instrument portal to computing devices of the users.

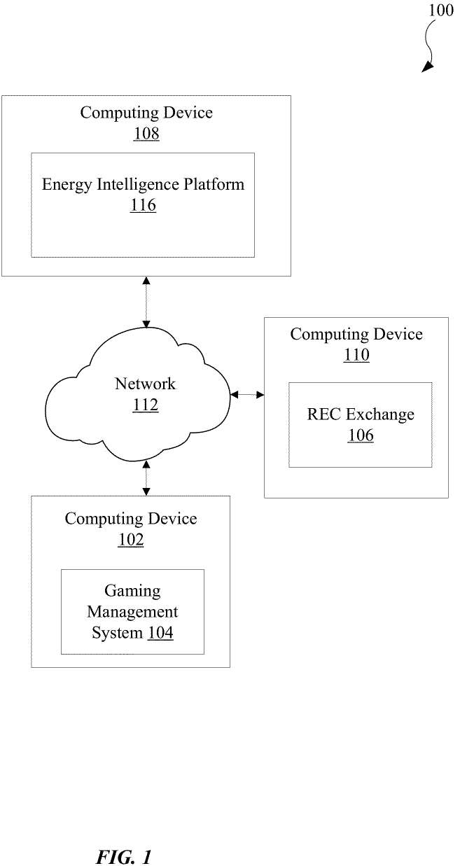

Turning now to the figures, FIG. 1 depicts a system architecture 100 according to some embodiments. The system architecture 100 may include one or more computing device s 102, 108, and/or 110. Although one computing device is depicted as respectively executing an energy intelligence platform 116, a gaming management system 104, and the REC exchange 106, more than one computing device may be used in a distributed architecture to perform one or more functions of the energy intelligence platform 116, the gaming management system 104, and/or the REC exchange 106. The gaming management system 104, the energy intelligence platform 116, and/or the REC Exchange 106 may be implemented in computer instructions stored on one or more memory devices and executable by one or more processing devices. The computing device 108 executing the gaming management system 104 may be communicatively coupled to the computing device 108 executing the energy intelligence platform 116 via network 112. The computing device 108 executing the energy intelligence platform 116 may be communicatively coupled to the computing device 110 executing the REC exchange 106 via the network 112. In some embodiments, the computing devices 102, 108, and/or 110 may be communicatively coupled to each other via the network 112.

Each of the computing devices 102, 108, and/or 110 may include one or more processing devices, memory devices, and/or network interface devices. The network interface devices may enable communication via a wired or wireless protocol for transmitting data over short distances, such as Bluetooth, NFC, etc. Additionally, the network interface devices may enable communicating data over long distances, and in one example, computing devices 102, 108, and/or 110 may communicate with the network 112. Network 112 may be a public network (e.g., connected to the Internet via wired (Ethernet) or wireless (WiFi)), a private network (e.g., a local area network (LAN) or wide area network (WAN)), or a combination thereof. Network 112 may also comprise a node or nodes on the Internet of Things (IoT).

The computing devices 102, 108, and/or 110 may be any suitable computing device, such as a laptop, a tablet, a smartphone, a computer, a server, a laptop computer, a tablet computer, a camera, a video camera, a netbook, a desktop computer, a media center, a gaming console, any other device capable of functioning as a server, or any combination of the above. The computing device 102 may include a display capable of presenting a user interface of a software application or website. The software application may be implemented in computer instructions stored on one or more memory devices of the computing device 102 and executable by one or more processing devices of the computing device 102. The website may be implemented in computer instructions and hosted by a server. The computing device 102 may execute a browser to access and interact with the website. The application or website may be implemented in computer instructions as the gaming management system 104. The gaming management system 104 may provide various functionality, such as a platform for installing, playing, buying, and/or streaming one or more video games. The gaming management system 104 may include a digital distribution service, a digital application storefront, a video game streaming service, a video streaming service, a social networking service, a digital rights management service, a server hosting service, etc.). In some embodiments, the gaming management system 104 may be hosted by a server or computing device external to the computing device 102.

The application or website may present various screens to a user. For example, the user interface may present a screen of a storefront application executed by the gaming management system 104. The screen may include an option to buy a virtual token that is associated with an offsetting instrument. The virtual token may be configured by a user of the gaming management system 104. Using a screen provided by the gaming management system 104, the user may use an input peripheral (e.g., mouse, keyboard, touchscreen, microphone) to select configuration input of one or more attributes associated with a functional feature and/or ornamental feature to configure for the virtual token. The energy intelligence platform 116 may receive the configuration input and configure the virtual token by modifying one or more attributes associated with the virtual token. For example, the energy intelligence platform 116 may modify one or more attributes pertaining to a carbon footprint offset of the user of the computing device 102 executing the gaming management system 104, an ornamental feature of the virtual token, a functional feature of the virtual token, or some combination thereof. The configuration input, the configured virtual token, and its attributes may be stored in a database of the energy intelligence platform 116 and/or the gaming management system 104.

The ornamental feature of the virtual token may include an appearance of the virtual token and may include a color, a shape, a size, a design, a graphic, text, a model mesh (e.g., polygon mesh), video, or some combination thereof. The ornamental feature may control the appearance of the virtual token presented by the gaming management system 104 and during in-game play of a video game session provided by the gaming management system 104.

The functional feature of the virtual token may include a function performed by the virtual token or a feature provided by the virtual token. The functional feature may be a “power up” that causes the virtual token to provide an altered amount of the attribute (e.g., increased or decrease amount, higher or lower amount, etc.) of an item or object represented by the virtual token than other objects that are not associated with the power up. For example, the virtual token may be a virtual motorcycle in a motorcycle racing video game, and the power up may enhance performance of the virtual motorcycle (e.g., faster revolutions per minute, higher driving speed, improved handling, etc.) as compared to other motorcycles that lack the power up. The functional feature may control the function of the virtual token during in-game play of a video game session provided by the gaming management system 104.

The virtual token, once purchased, may be generated and transmitted from the energy intelligence platform 116 to the gaming management system 104. The energy intelligence platform 116 may determine a purchase price of the virtual token based on a carbon footprint offset of one or more users. The energy intelligence platform 116 may consider numerous factors when determining the purchase price, such as time of day energy is consumed, location, cost of energy, amount of energy consumed, historical purchases, and so forth. The energy intelligence platform 116 may determine that a certain number of RECs (e.g., 5) should be bought to offset the user’s carbon footprint. The number of RECs may be factored into determining the purchase price of the virtual token. The energy intelligence platform 116 may transmit a bulk purchase request to the REC exchange 106. The REC exchange 106 may purchase the RECs, transfer ownership of the RECs to the user, and retire the RECs using an identity of the user and/or the gaming management system 104.

A confirmation may be transmitted by the REC exchange 106 to the energy intelligence platform 116. In some embodiments, the RECs may be transmitted to the energy intelligence platform 116. In some embodiments, the energy intelligence platform 116 generates and transmits the virtual token to the gaming management system 104 to be deployed during a video game session according to the configured attributes.

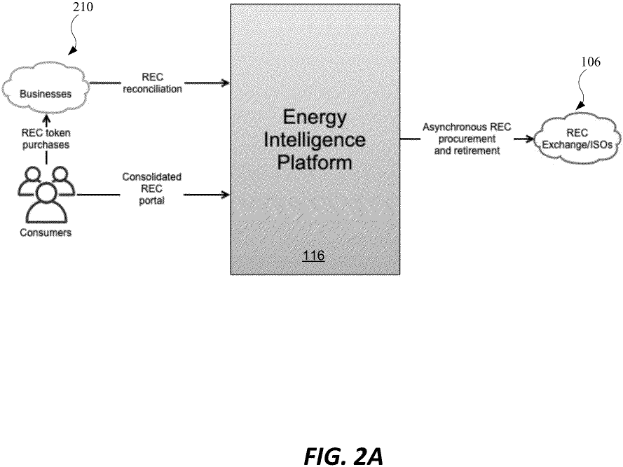

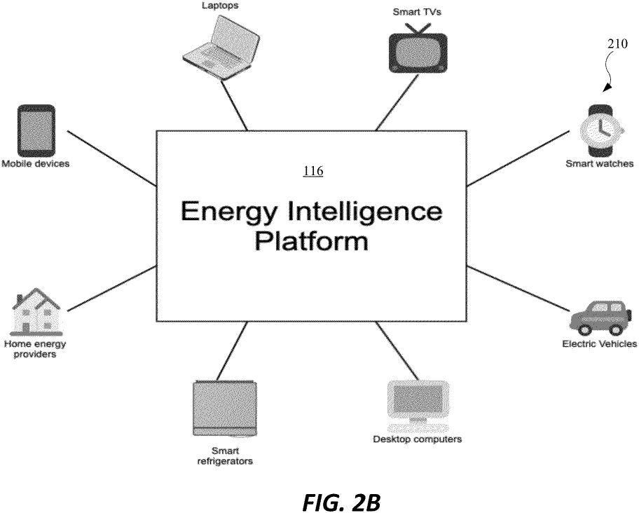

FIG. 2A illustrates a high-level component diagram using the energy intelligence platform 116 according to certain embodiments of this disclosure. Various businesses 210 may operate a software application or service that integrates with the energy intelligence platform 116. For example, an application programming interface of the energy intelligence platform 116 may be used to enable the businesses’ 210 software application or service to integrate with and use functionality of the energy intelligence platform 116. In one example embodiment, the gaming management system 104 may be developed and provided by one of the businesses 210 (represented by a cloud). In another example, an ecommerce software application or website may be developed and provided by one of the businesses 210.

Consumers or users may select to purchase an REC virtual token using a software application or website provided by one of the businesses 210. The software application or website may transmit a request to the energy intelligence platform 116 to reconcile a REC. The energy intelligence platform 116 may transmit a virtual token associated with the carbon footprint offset to the software application or website to be presented and/or used. The energy intelligence platform 116 may asynchronously transmit messages to the REC exchange 106 to transfer ownership of the REC to an identity of the user that purchased the virtual token and retire the REC using the user’s identity.

In some embodiments, a consolidated REC portal may be accessed by the consumers or users. The consolidated REC portal may be implemented in computer instructions stored on one or more memory devices and executed by one or more processing devices. The consolidated REC portal may refer to a user interface screen associated with the energy intelligence platform 116. The consolidated REC portal may enable presenting one or more graphical elements associated with the RECs and/or other offsetting instruments purchased and retired by the user. In some embodiments, the consolidated REC portal may be publicly accessed such that other users can view each of the users REC statistics. The consolidated REC portal may present various rewards or awards for the user if the user has satisfied one or more thresholds of offsetting their carbon footprint. In some embodiments, the consolidated REC portal may present REC statistics, rewards, virtual tokens, and/or awards associated with multiple gaming management systems. That is, the REC portal consolidates the information (e.g., offsetting instruments associated with the user) associated with numerous gaming management systems and presents the information in a user interface.

FIG. 2B illustrates various energy consuming computing devices 210 according to certain embodiments of this disclosure. As depicted, the energy consuming computing devices 210 may include one or more smart watches, smart televisions, laptops, mobile devices, home energy providers, smart refrigerators, desktop computers, and/or electric vehicles, among others. The energy consuming computing devices 210 may be communicatively coupled to the energy intelligence platform 116. The energy intelligence platform 116 may collect various information pertaining to the energy used by the energy consuming computing devices 210, including the amount of energy used to charge the energy consuming computing devices 210. In some embodiments, a software agent application may be downloaded and installed on each of the energy consuming computing devices 210. The software agent application may determine when the energy consuming computing devices 210 are charging and an amount of time the energy consuming computing devices 210 charge. The software agent application may determine the amount of energy consumed by the amount of time the energy consuming devices 210 charge.

Other information may be determined by the software agent application, such as usage patterns of the energy consuming device 210 (e.g., most used application, least used application, time of use, etc.), user preferences, and the like. The software agent application may transmit any obtained information to the energy intelligence platform 116 to enable the energy intelligence platform 116 to determine a carbon footprint offset of the user based on the energy consumed by the energy consuming devices 210. The carbon footprint offset may enable determining a price of the virtual token based on how many RECs are needed to be purchased to offset the user’s carbon footprint.

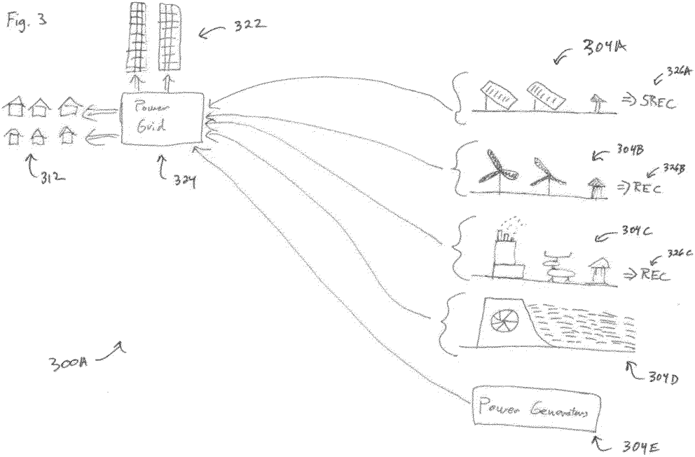

FIG. 3 illustrates a power infrastructure 300. A power infrastructure 300 may take energy from any number of generators or producers such as but not limited to solar energy 304A, wind energy 304B, alternative fuel energy 304C, hydro energy 304D, or other energy sources 304E, and provide those to commercial buildings and homes 312. The power infrastructure 300 may be facilitated by industrial power control system 322 and the power grid 324. In at least one embodiment, the power grid 324 represents the distribution network and transmission lines that provide the transport mechanism for power from generation sites to consumption sites. Those same sites, such as commercial buildings and homes 312, may use energy that is produced by green or renewable energy sources. One way to guarantee that the power consumed is green or renewable is through the purchase of renewable energy certificates. Renewable energy sources such as solar energy 304A and wind energy 304B can generate renewable energy certificates such as solar energy certificates 326A, renewable energy certificates 326B, and/or alternative energy certificates or incentives 326C.

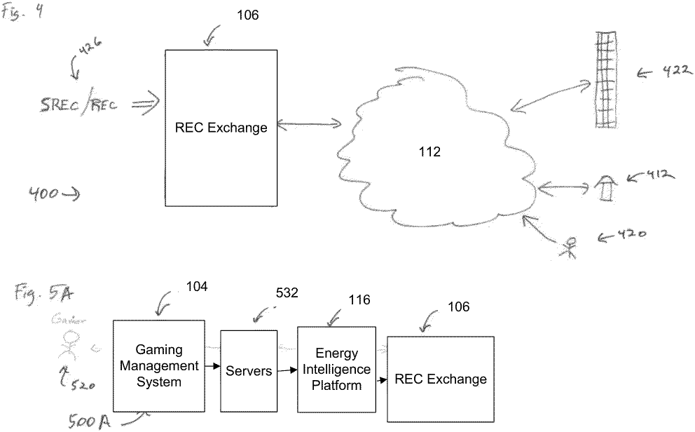

FIG. 4 is an illustration of a renewable energy certificate exchange. A certificate exchange and internet infrastructure 400 can allow for renewable energy certificates (REC) 426 to be traded or exchanged between individuals or homes 412 and businesses 410. A user 420 can access a REC Exchange 428 via the network 112 to purchase certificates that can be retired in the name of that business or individual. By purchasing certificates and retiring them, that energy credit amount is purchased to offset carbon emissions in that amount. For example, if a home 412 uses 1 MW of energy a year, they can purchase a REC worth 1 MW of energy and retire that certificate to offset the carbon emissions.

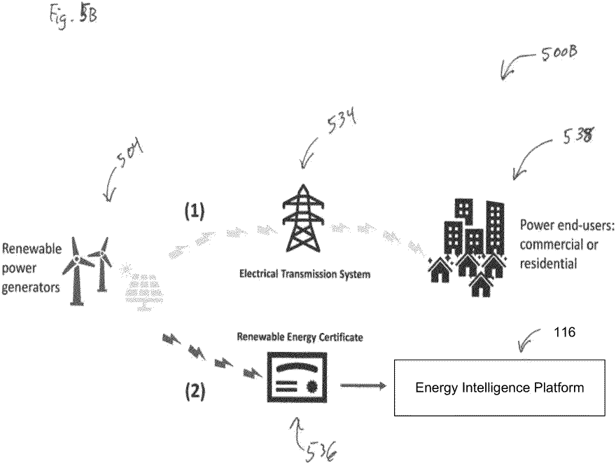

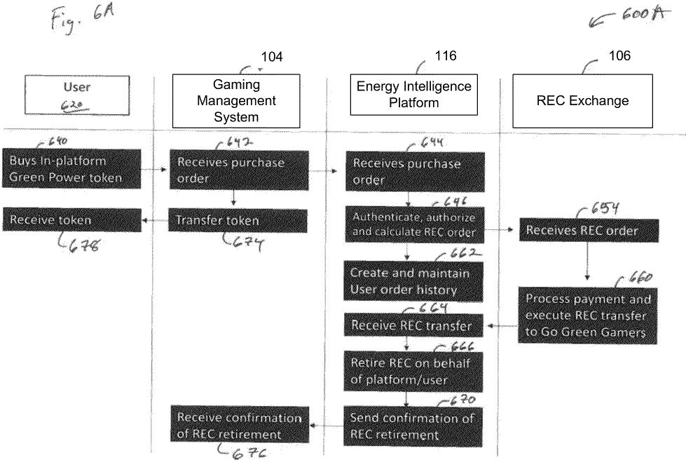

FIG. 5A illustrates a Renewable Energy Certificate (REC) management system 500A. The REC management system 500A allows a user 520 to purchase and manage RECs via gaming and other ecommerce management systems. For example, a user 520 plays a video game on a gaming management system 104 that allows for in-game purchases. The user 520 selects one of the in-game purchases, which sends the purchase request to the gaming management system 104 servers 532. The gaming management system 104 sends the requests to the energy intelligence platform 116 (“GoGreenGamers”) that makes the purchase request to a REC exchange 106.

The REC exchange 106 facilitates a purchase and returns the certificate and/or a retirement confirmation to the energy intelligence platform 116, which provides the information to the gaming management system 104. During the purchase confirmations, a virtual token, medallion, or another item can be provided to the user’s gaming management system account for use within one or more video games. While gaming is provided as the illustration, the energy intelligence platform 116 may also be linked with ecommerce platforms or other types of wagering or gaming systems.

For example, an ecommerce platform could replace the gaming management system 104, and the ecommerce servers could replace the gaming servers 532. In these examples, the ecommerce platform could offer a reward equivalent to the amount of energy purchased or carbon offsets purchased. Similarly, if a wagering system replaces the gaming system, the amount of energy utilized could be offset with a percentage of the winnings or other calculations. Alternatively, wagers for users who make green or renewable contributions may receive bonuses or increased odds of winning.

FIG. 5B illustrates a Renewable Energy Certificate (REC) management system 500B. An alternative view of the REC management system 500B provides how power systems and RECs interact. For example, energy sources 504 produce energy in multiple forms. Some are from renewable or green sources, others are from alternative fuels, and others are from fossil fuels. The renewable or green sources can often generate RECs 536 equivalent to the amount of energy produced for a given time period. For example, if a solar energy farm produces 5 MWs every day, then it can generate five Solar RECs every day. Since consumers of energy, i.e., homes 512 or commercial buildings, cannot know if the energy they utilize comes from a renewable or green source, these individuals or facilities can purchase RECs equivalent to, less than, or greater than their production. The produced energy is provided to the power grid 534 for transmission, conditioning, and/or control. The power grid 534 makes the power/energy available for the homes 512 and/or commercial buildings.

The RECs can be managed by energy intelligence platform 116. The energy intelligence platform 116 can manage RECs and/or similar instruments for gaming, ecommerce, gambling or wagering, and individual users (e.g., gamers). For example, a gamer may be from a city and/or state where there is minimal renewable energy production. When his purchase request is made, a calculation may be performed to facilitate REC purchases. In at least one example, the user’s past REC purchase history can also be accounted for to create a more substantial virtual token or award, determine the purchase price, and/or generate a virtual token that matches one or more of the user’s attributes. “Matching” may refer to a virtual token that is customized to one or more attributes of the user (e.g., based on demographics, psychographics, geographic location, preferences, etc.) With regards to ecommerce management systems, the calculations may take into account how much of the cart (e.g., a software application that facilitates the purchase of an item (virtual token, product, offsetting instrument, or service) by presenting a representation of that item and provides payment processing capabilities) is green, recycled, or sustainable to determine the purchase price of the resulting carbon footprint offset. Additional calculations may incorporate the amount of energy the computing device the user utilized to connect with the energy intelligence platform 116 consumes on average in a day or other specified time periods. Additional calculations may incorporate the amount of energy the computing device the user utilized to play video games consumes on average in a day or other specified time periods.

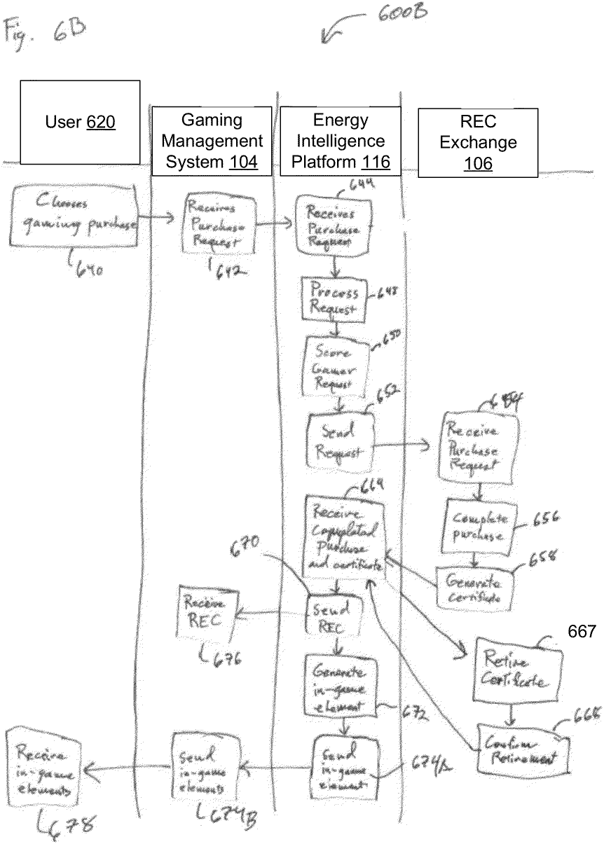

FIG. 6A illustrates an operational flow 600A of interactions with the energy intelligence platform 116. The energy intelligence platform 116 can interact with a user 620 through a gaming management system 104 to allow for the purchase of RECs in exchange for in-app or in-game purchases such as virtual tokens (e.g., awards, power-ups, custom designs, preferential odds or events, and/or other similar options).

A user 620 may initialize an in-platform purchase of a virtual token, such as but not limited to a green power token, that is associated with one or more awards, power-ups, custom designs, preferential odds or events, and/or other similar options to be received in exchange for making a purchase, in which at least a portion of the purchase goes towards the purchase of a REC 640. The virtual token may include an attribute configured based on a carbon footprint offset of the user of the computing device executing the gaming management system 104. The gaming management system 104 can receive the purchase order or request for processing 642. When the purchase order is received (642), the gaming management system 104 can transfer a data set of information to the energy intelligence platform 116 to process a received purchase order (644).

Upon receiving (644) the purchase order 644, the REC management system 634 can then perform processing (646) operations to authenticate, authorize, and/or calculate the REC order. For example, the gamer may need to be authenticated through a credit card or other identifying information (e.g., credentials). Similarly, the same information may be needed to authorize the purchase of a REC in the user’s 620 name or identity. The calculations for a REC order may include historical information, location information, and/or game incentive information. For example, a user 620 from a region with significant renewable energy production may pay less for a REC than one living in an area with less renewable energy production.

The energy intelligence platform 116 can create, maintain, and/or store user order history (662) for subsequent calculations. For example, a user 620 may play across multiple gaming management systems 104 and can benefit from purchasing RECs from any gaming management systems. The creation and maintenance of user order history (662) can allow users 620 to access the energy intelligence platform 116 for tax incentives or paperwork. In at least one example, the energy intelligence platform 116 may utilize anonymous data to provide renewable energy producers an idea of potential markets, consumption zones, and/or the types of renewable energy credits available. One example of this could be the percentage of users 620 purchasing RECs within 100 miles of a renewable energy production source.

The energy intelligence platform 116 can send the REC order to the REC exchange 106. The REC exchange 106 may receive (654) the REC order. The REC order can be processed (660) by the REC exchange 106 along with the payment, and a transfer of the REC to the energy intelligence platform 116 may be initialized. It should be noted that the energy intelligence platform 116 or REC exchange 106 may compile several REC orders together prior to purchasing to allow for a complete purchase order. In these examples, the payment would be a multistep process with one or both parties acting as an intermediary for the gaming management system 104 or user 620. The energy intelligence platform 116 may receive the REC transfer (664) from the REC exchange 106. In some examples, the transfer may include one or more RECs or retirements.

The received RECs can then be retired on behalf of the gaming management system 104 and/or user 620. While illustrated as being performed by the energy intelligence platform 116, it would be understood that the energy intelligence platform 116 may request the REC exchange 106 to perform the retirement prior to or after the transfer. Upon retirement of the REC, the energy intelligence platform 116 can send a confirmation of the REC retirement to the gaming management system 104 and/or user 620. When the platform receives (676) the confirmation of REC retirement, or upon confirmation of the purchase request, the gaming management system 104 can interact with the user 620 to provide them the virtual token (e.g., reward) for making the purchase. For example, in a gaming management system 104, a virtual token can be transferred (674) to the user. The user 620 may receive (678) the virtual token or other reward in the gaming management system 104. Upon receiving the virtual token, the token or reward may be utilized or shown as part of an event or in-game aspect during a video game session.

FIG. 6B illustrates an operational flow 600B of an energy intelligence platform 116. The energy intelligence platform 116 can interact with a user 620 through the gaming management system 104 to allow for the purchase of RECs in exchange for in-app or in-game purchases, such as virtual tokens (e.g., awards, power-ups, custom designs, preferential odds or events, and/or other similar options).

A user 620 initializes an in-platform purchase (640) of a virtual token, such as but not limited to a green power token, that allows for virtual tokens (e.g., awards, power-ups, custom designs, preferential odds or events, and/or other similar options) to be received in exchange for making a purchase. A portion of the purchase price of the virtual token is used to purchase a REC. The gaming management system 104, can receive the purchase order or request for processing (642). When the purchase order is received (642), the gaming management system 104 can transfer (644) a data set of information to the energy intelligence platform 116 to process a received purchase order.

After receiving the purchase request, the gaming management system 104 may process (648) the request. Processing can include many different steps or operations, but in at least one example, processing can include extrapolating data, confirming secure data transfer, decrypting secure data such as credit card or other payment information, gathering data from multiple unrecognizable or incompatible sources, recompiling data into usable forms, and/or reencrypting data into a secure form. The processing can allow the energy intelligence platform 116 to utilize a complete data resource in analysis, preparation, and/or execution of various functions and/or operations.

The energy intelligence platform 116 may enable scoring (650) of the user’s 620 request in conjunction with or sequentially with the processing of the request. The scoring of a user’s request can account for the distance from the closest renewable energy generation source, how much renewable energy generation is within a specified distance from the user’s location, how many RECs the user has previously purchased, a user’s rank within a game, the history of purchases from an ecommerce platform, and/or the energy consumed on average by the computing device 102 operating the gaming management system 104. The scoring can then be utilized to ensure that a proper purchase amount is allocated for the user and/or the gaming management system 104.

The purchase request can be sent (652) to the REC exchange 106 from the energy intelligence platform 116. The REC exchange 106 can receive (654) the purchase request and perform actions necessary to confirm payment, purchasing information, and any information for the certificates. The REC exchange 106 can then complete (656) the purchase using the information provided. Upon completion of the purchase, the REC exchange 106 can generate (658) a REC with the REC information.

The energy intelligence platform 116 can receive (664) the completed purchase and REC from the REC exchange 628. The RECs can then be retired (667), and the retirement confirmed (668). The retirement and confirmation can be performed by the energy intelligence platform 116 or the REC exchange 106.

The energy intelligence platform 116 can send (670) the REC confirmation to the gaming management system 104. The gaming management system 104 can receive the REC (676) and perform or execute confirmation steps to reward the user 620 for making the purchase.

In at least one example, a virtual token (e.g., an in-game element, in-app element, or branding) from the energy intelligence platform 116 is generated (672) to provide to the gaming management system 104 and allow for cross-branding and licensing of technology and/or interest in renewable energy and renewable energy credits. The in-app or in-game element, once generated, can be sent (674A) to the gaming management system 104. The gaming management system 104 can receive the token or other element (674B) and provide it to a user or allow a user to receive the benefit of the token or element (678).

Some examples of the present disclosure may include combinations of that described above, in various configurations. For example, an energy intelligence platform 116 may receive a purchase request from a gaming management system 104 and allow for a purchase request to be processed. The purchase request can then be assigned a purchase amount and linked to the proper entities and individuals. A REC purchase can then be made from the energy intelligence platform 116 in the name of an entity and/or individual who made the purchase request. The REC may be retired in the name of entity and/or individual, and then a confirmation of the REC purchase and retirement can be made to the gaming management system 104.

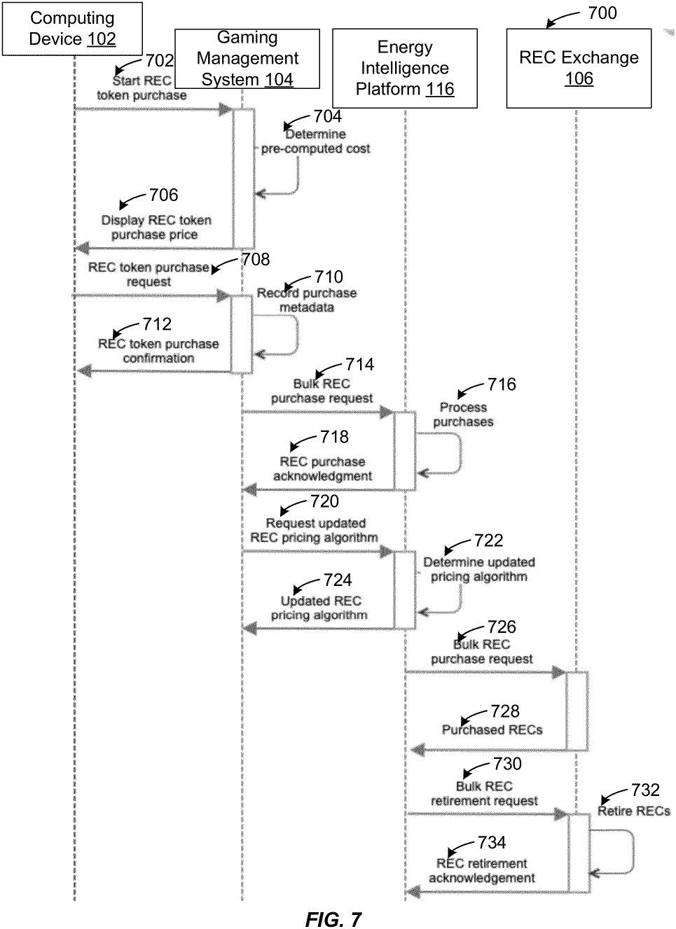

FIG. 7 illustrates an asynchronous operational flow 700 of interactions with an energy intelligence system 116 according to certain embodiments of this disclosure. The flow 700 begins (702) with a consumer or user (e.g., gamer) initiating, using the computing device 102, a purchase of a virtual token associated with an REC. The computing device may initiate the purchase of the virtual token when a user logs in to the gaming management system 104, for example. The gaming management system 104 may determine (704) a pre-computed cost of the virtual token based on one or more users’ carbon footprint offsets of one or more energy consuming devices. For example, the pre-computed cost may have been previously computed and stored in memory associated with the gaming management system 104. The gaming management system 104 may display (706) the purchase price of the virtual token in a user interface of a storefront application. The gaming management system 104 may also display the virtual token (e.g., graphical object or graphical item). The computing device 102 may transmit (708) a purchase request to the gaming management system 104. The gaming management system 104 may receive a purchase request for the virtual token. The gaming management system 104 may record (710) purchase metadata associated with the virtual token. The purchase metadata may include an identity of the user making the purchase, the purchase price of the virtual token, the carbon footprint offset of the one or more users, and the like.

In some embodiments, the gaming management system 104 may transmit (712) a virtual token purchase confirmation to the computing device 102. The gaming management system 104 may transmit (714) a bulk REC purchase request (based on the number of RECs determined above) to the energy intelligence system 116. The energy intelligence system 116 may process (716) the REC purchases by validating credentials of the user that made the purchase request, by verifying a computing device of the user who made the purchase request, by performing one or more cryptographic techniques to ensure the purchase requests were transmitted securely, and the like.

In some embodiments, the gaming management system 104 may request (720) an updated REC pricing algorithm from the energy intelligence system 116. The energy intelligence system 116 may determine (722) the updated pricing algorithm. The updated pricing algorithm may account for various factors, such as the wholesale market price of RECs, the energy-use calculation for gaming and/or ecommerce users, the configuration of electrical generation sources on the power grid in the user’s locale, or some combination thereof. The energy intelligence system 116 may transmit (724) the updated REC pricing algorithm to the gaming management system 104. The energy intelligence system 116 may transmit (726) a bulk REC purchase request to the REC exchange 106. The bulk REC purchase request may include payment information for the user, an identity of the user, an amount of RECs to purchase, and the like. The REC exchange 106 may execute the purchase by transferring funds from an account associated with the energy intelligence platform to the seller of the REC or to the REC exchange 106 and transferring ownership of the RECs to the identity of the user, to the gaming management system 104, or both. The REC exchange 106 may transmit (728) the purchased RECs to the energy intelligence platform 116. The energy intelligence platform 116 may transmit (730) a bulk REC retirement request to the REC exchange 106. The bulk REC retirement request may include information related to the identity of the owner of the RECs, unique identifiers of the RECs, and the like.

The REC exchange 106 may retire (732) the RECs by associating the RECs permanently with the identity of the user and/or entity in a database, setting a flag that the RECs are retired in a database, removing the RECs from circulation, or the like. The REC exchange 106 may transmit (734) an REC retirement acknowledgement to the energy intelligence platform 116.

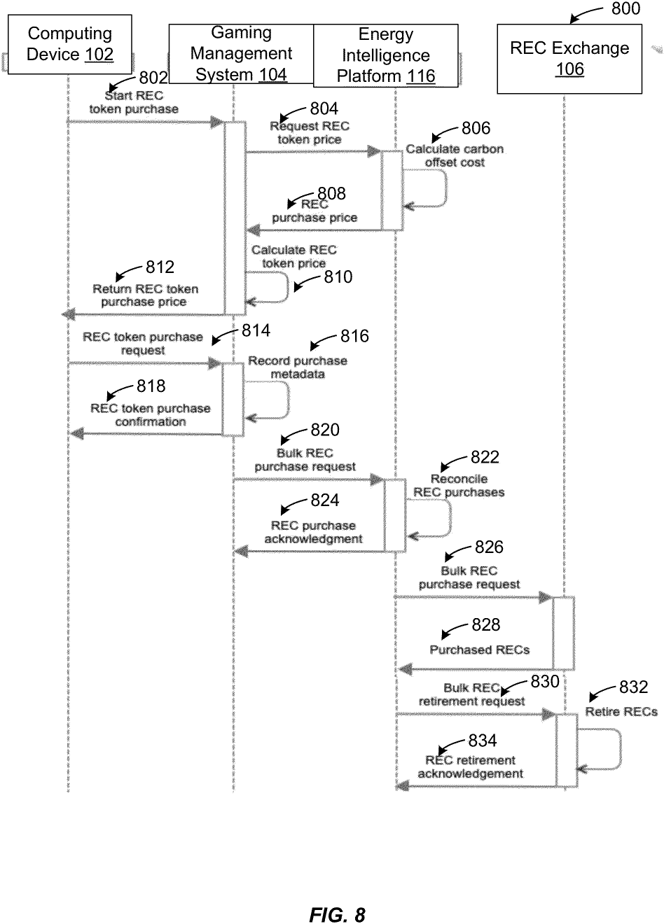

FIG. 8 illustrates a hybrid operational flow of interactions with an energy intelligence system 116 according to certain embodiments of this disclosure. The flow 800 begins (802) with a consumer or user (e.g., gamer) initiating, using the computing device 102, a purchase of a virtual token associated with an REC. The computing device may initiate the purchase of the virtual token when a user logs in to the gaming management system 104, for example. The gaming management system 104 may request (804) an REC virtual token price from the energy intelligence system 116. The energy intelligence platform 116 may calculate (806) the carbon offset cost for one or more users. For example, the energy intelligence platform 116 may use energy usage information pertaining to the users and determine an average carbon footprint offset for the group of users. In some embodiments, the energy intelligence platform 116 may determine the carbon footprint offset for the requesting user. Calculating the carbon offset cost may also account for the level of renewable energy certificates (RECs) for a location of a user and a location of the gaming management system 104, historical purchases, and renewable generation by location. Calculating the carbon offset cost may include determining how many RECs to purchase to offset the one or more users’ carbon footprint. The carbon offset cost may be used to determine an REC purchase price for the user. The energy intelligence platform 116 may transmit (808) the REC purchase price to the gaming management system 104.

The gaming management system 104 may receive the REC purchase price and use it to calculate (810) an REC virtual token price. The REC virtual token price may include the REC purchase price, as well as other costs, such as taxes, markups, or the like. The gaming management system 104 may return (812) the REC virtual token purchase price for display in a storefront application on the computing device 102. The computing device 102 may transmit (814) an REC token purchase request to the gaming management system 104. The gaming management system 104 may record (816) purchase metadata. The gaming management system 104 may transmit (818) an REC virtual token purchase confirmation to the computing device 102. In some embodiments, the REC virtual token purchase confirmation may include the virtual token that is generated and configured to be deployed in-game of a video game session according to one or more attributes (e.g., functional feature, ornamental feature, etc.).

In some embodiments, the gaming management system may transmit (820) a bulk REC purchase request to the energy intelligence platform 116. The energy intelligence platform 116 may reconcile (822) the REC purchases. The energy intelligence platform 116 may reconcile the REC purchases by verifying they include the right number of REC purchases at the right purchase price. The energy intelligence platform 116 may transmit (824) an REC purchase acknowledgement to the gaming management system 104.

In some embodiments, the energy intelligence platform 116 may transmit (826) a bulk REC purchase request to the REC exchange 106. The REC exchange 106 may purchase the RECs from one or more sellers and transmit (828) the purchase RECs to the energy intelligence platform 116. The energy intelligence platform 116 may then transmit (830) a bulk REC retirement request to the REC exchange 106. The bulk REC retirement request may identify the RECs to be retired, the identities of the user and/or entity associated with the RECs, and the like. The REC exchange 106 may retire (832) the RECs in the name or identity of the user and/or entity. The REC exchange 106 may transmit (834) an REC retirement acknowledgement to the energy intelligence platform 116.

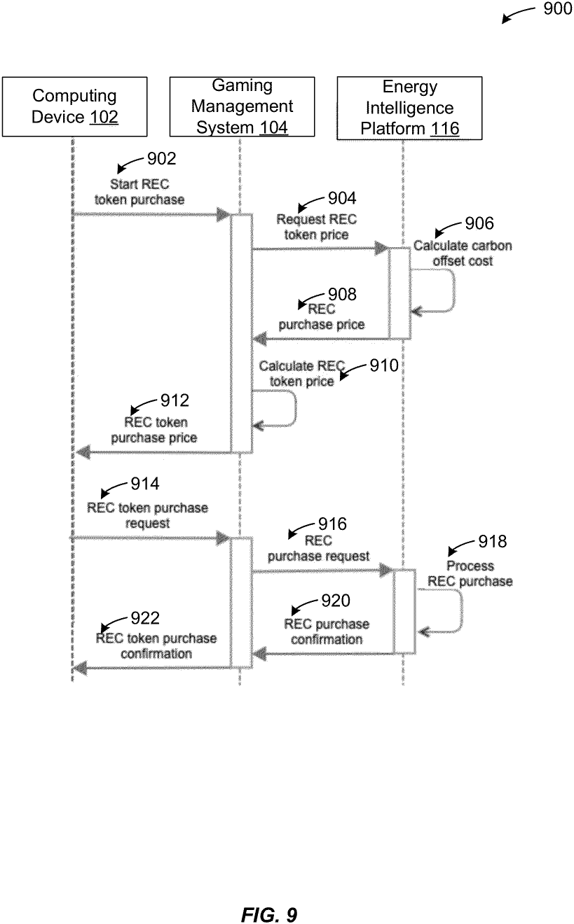

FIG. 9 illustrates a synchronous operational flow 900 of interactions with an energy intelligence system 116 according to certain embodiments of this disclosure. The flow 900 begins (902) with a consumer or user (e.g., gamer) initiating, using the computing device 102, a purchase of a virtual token associated with an REC. The computing device may initiate the purchase of the virtual token when a user logs in to the gaming management system 104, for example. The gaming management system 104 may request (904) an REC virtual token price from the energy intelligence system 116. The energy intelligence platform 116 may calculate (906) the carbon offset cost for one or more users. For example, the energy intelligence platform 116 may use energy usage information pertaining to the users and determine an average carbon footprint offset for the group of users. In some embodiments, the energy intelligence platform 116 may determine the carbon footprint offset for the requesting user. Calculating the carbon offset cost may also account for the level of renewable energy certificates (RECs) for a location of a user and a location of the gaming management system 104, historical purchases, and renewable generation by location. Calculating the carbon offset cost may include determining how many RECs to purchase to offset the one or more users’ carbon footprint. The carbon offset cost may be used to determine an REC purchase price for the user. The energy intelligence platform 116 may transmit (908) the REC purchase price to the gaming management system 104.

The gaming management system 104 may receive the REC purchase price and use it to calculate (910) an REC virtual token price. The REC virtual token price may include the REC purchase price, as well as other costs, such as taxes, markups, or the like. The gaming management system 104 may return (912) the REC virtual token purchase price for display in a storefront application on the computing device 102. The computing device 102 may transmit (914) an REC virtual token purchase request to the gaming management system 104.

In some embodiments, the gaming management system 104 may transmit (916) a REC purchase request to the energy intelligence platform 116. The energy intelligence platform 918 may process (918) the REC purchase by purchasing the requested REC(s). The energy intelligence platform 116 may transmit (920) an REC purchase confirmation to the gaming management system 104. The gaming management system 104 may transmit an REC virtual token purchase confirmation to the computing device 102.

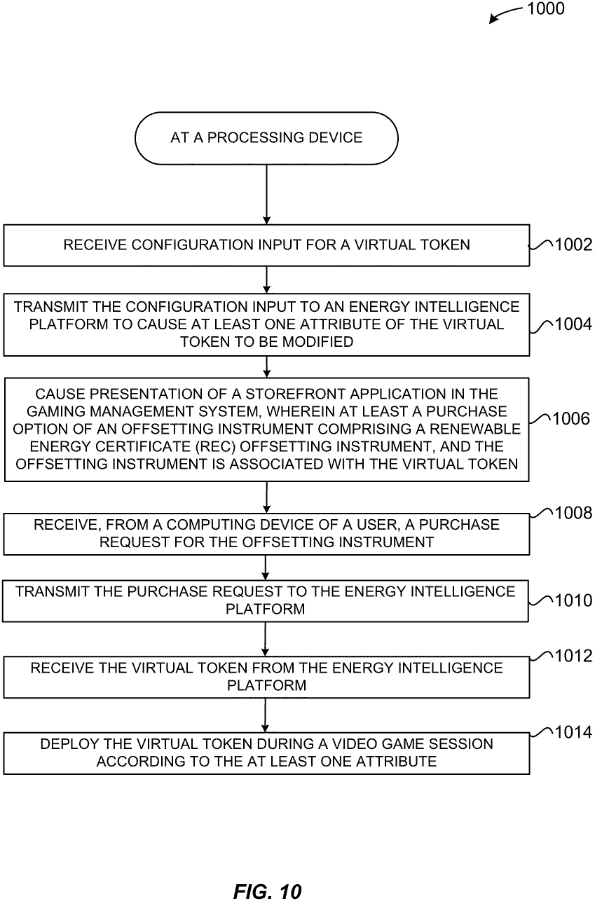

FIG. 10 illustrates an example of a method for a gaming management system according to certain embodiments of this disclosure. The method 1000 may be performed by processing logic that may include hardware (circuitry, dedicated logic, etc.), software, or a combination of both. The method 1000 and/or each of their individual functions, subroutines, or operations may be performed by one or more processors of a computing device (e.g., computing devices 108, 102, and/or 110 of FIG. 1) implementing the method 1000. The method 1000 may be implemented as computer instructions stored on a memory device and executable by the one or more processors. In certain implementations, the method 1000 may be performed by a single processing thread. Alternatively, the method 1000 may be performed by two or more processing threads, each thread implementing one or more individual functions, routines, subroutines, or operations of the methods. In some embodiments, the method 1000 is performed by a processing device executing the energy intelligence platform 104.

At block 1002, the processing device may receive configuration input for a virtual token. One or more application programming interfaces of the energy intelligence platform 116 and/or the gaming management system 104 may enable a user to enter the configuration input (e.g., one or more parameters, attributes, elements, components, etc.) for the virtual token. The configuration input may be selected using one or more graphical elements on a user interface. In some embodiments, the configuration input may be received as a digital file, such as an extensible markup language (XML) file format, flat file format, or the like. The digital file may represent the attributes as key-value pairs or with tags.

At block 1004, the processing device may transmit the configuration input to the energy intelligence platform 116 to cause at least one attribute of the virtual token to be modified. The energy intelligence platform 116 may receive the configuration input. The configuration input may specify that the attribute of the virtual token is modified to perform a specific function when deployed in a video game session, or exhibit a specific ornamental feature when represented by the gaming management system 104. Accordingly, in some embodiments, the virtual token may be associated with an ornamental feature of the virtual token (e.g., an appearance, such as a color, shape, size, text, image, graphic, etc.), a functional feature of the virtual token, or some combination thereof.

At block 1006, the processing device may cause presentation of a storefront application in the gaming management system 116. At least a purchase option of an offsetting instrument including an REC is presented in a screen of the storefront application. The offsetting instrument may be associated with the virtual token by the energy intelligence platform 116 or by the gaming management system 116.

At block 1008, the processing device may receive, from a computing device of a user, a purchase request for the offsetting instrument. The energy intelligence platform 116 may determine a number of offsetting instruments that represent an average of multiple users’ carbon footprint offsets of one or more computing devices. The energy intelligence platform 116 may use energy usage information related to the computing devices, battery charging information related to the computing devices, and the like. The energy intelligence platform 116 may generate a renewable energy score for the purchase request based on a location of the computing device, historical purchase, time of day energy is used, renewable purchases by location, or some combination thereof. The score of the purchase request may be used by the gaming management system 104 to rank the user and the ranking may be used to determine a purchase price for the virtual token.

At block 1010, the processing device may transmit the purchase request to the energy intelligence platform 116. The energy intelligence platform 116 may cause the offsetting instruments to be retired for the user and/or the gaming management system 104. The energy intelligence platform 116 may confirm retirement of the offsetting instrument by transmitting a confirmation message to the gaming management system 104 to be presented to the user. Retiring the offsetting instrument may refer to an offsetting instrument exchange removing the certificate from circulation by associating the offsetting instrument permanently with the identity of the user in a tracking system. The tracking system may store the association in a data structure of a memory device.

At block 1012, the processing device may receive the virtual token from the energy intelligence platform 116. The virtual token may be presented in a user interface of the gaming management system 104. In some embodiments, the virtual token may be associated with a certain video game. The user may select an option to initiate a video game session for the certain video game. The gaming management system 104 may launch the video game session.

At block 1014, the processing device may deploy the virtual token during the video game session according to the at least one attribute. Deploying the virtual token according to the at least one attribute may refer to controlling, based on the at least one attribute, the functionality and/or presentation of the virtual token during the video game session. The video game session may be provided by the gaming management system 104 executing the video game, and the video game session may be presented on a display device of the computing device 102.

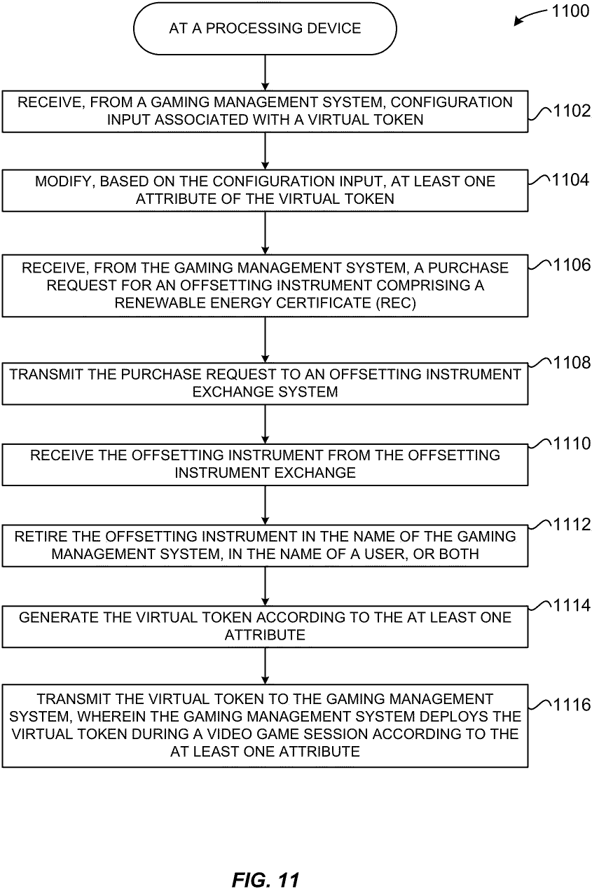

FIG. 11 illustrates an example of a method 1100 for an energy intelligence platform according to certain embodiments of this disclosure. The method 1100 may be performed by processing logic that may include hardware (circuitry, dedicated logic, etc.), software, or a combination of both. The method 1100 and/or each of their individual functions, subroutines, or operations may be performed by one or more processors of a computing device (e.g., gaming management system 104, energy intelligence platform 116, computing device 102, and/or REC exchange 106 of FIG. 1) implementing the method 1100. The method 1100 may be implemented as computer instructions stored on a memory device and executable by the one or more processors. In certain implementations, the method 1100 may be performed by a single processing thread. Alternatively, the method 1100 may be performed by two or more processing threads, each thread implementing one or more individual functions, routines, subroutines, or operations of the methods. In some embodiments, the method 1100 is performed by a processing device executing the energy intelligence platform 116.

At block 1102, the processing device may receive, from the gaming management system 104, configuration input associated with a virtual token. The configuration input may specify that the attribute of the virtual token is modified to perform a specific function when deployed in a video game session, or exhibit a specific ornamental feature when represented by the gaming management system 104. Accordingly, in some embodiments, the virtual token may be associated with an ornamental feature of the virtual token (e.g., an appearance, such as a color, shape, size, text, image, graphic, etc.), a functional feature of the virtual token, or some combination thereof.

At block 1104, the processing device may modify, based on the configuration input, at least one attribute of the virtual token. In some embodiments, the processing device may modify a second attribute of the virtual token, wherein the second attribute pertains to a carbon footprint offset of the user of a computing device executing the gaming management system 104.

At block 1106, the processing device may receive, from the gaming management system 116, a purchase request for an offsetting instrument including a renewable energy certificate (REC) or similarly marketed instrument. The energy intelligence platform 116 may determine a purchase price of the carbon footprint offset of one or more computing devices of the user. In some embodiments, the energy intelligence platform 116 may determine a number of offsetting instruments to purchase to offset the user’s carbon footprint. The purchase price of the carbon footprint offset may be associated with and presented with the virtual token in a storefront application of the gaming management system 104.

At block 1108, the processing device may transmit the purchase request to an offsetting instrument exchange system. The offsetting instrument exchange system may purchase the offsetting instrument and transfer ownership of the offsetting instrument to the identity of the user and/or the gaming management system 104. At block 1110, the processing device may receive the offsetting instrument from the offsetting instrument exchange system.

At block 1112, the processing device may retire the offsetting instrument in the name of the gaming management system 104, in the name of a user, or both. For example, the energy intelligence platform 116 may transmit, to the offsetting instrument exchange 106 system, a request to retire the offsetting instrument. The ownership of the offsetting instrument may be transferred to an identity of the user. The energy intelligence platform 116 may receive a confirmation that the offsetting instrument exchange 116 system has retired the offsetting instrument.

At block 1114, the processing device may generate the virtual token according to the attributes. In some embodiments, the gaming management system 104 may generate the virtual token. The virtual token may refer to a graphical element or object that is associated with one or more attributes that specify the graphical element or object’s functions and/or appearance, and/or that pertain to a carbon footprint offset of the user of a computing device executing the gaming management system 104.

At block 1116, the processing device may transmit the virtual token to the gaming management system 104, and the gaming management system 104 may deploy the virtual token during a video game session according to the attribute that modifies an ornamental feature of the virtual token and/or a functional feature of the virtual token in the video game session.

In some embodiments, the processing device executing the energy intelligence platform 116 may aggregate multiple purchase requests. At a predetermined time, the processing device may transmit a bulk purchase request for multiple offsetting instruments to the offsetting instrument exchange 106 system. The processing device may receive the offsetting instruments. In some embodiments, at a second predetermined time, the processing device may transmit a bulk retirement request to the offsetting instrument exchange system to retire the offsetting instruments. The processing device may receive an acknowledgement that the offsetting instruments are retired.

In some embodiments, the processing device may receive, from one or more agent applications executing one or more computing devices of users, energy usage information of the one or more computing devices. Further, in some embodiments, the processing device may use the energy usage information to determine the purchase price of the virtual token.

In some embodiments, the processing device may provide, via an application programming interface, the virtual token to a social media platform to be associated with a user profile of the user. The application programming interface may be hosted and provided by the social media platform and the energy intelligence platform 116 may communicatively connect to the application programming interface to make one or more function calls. In some embodiments, the application programming interface may enable posting the virtual token in a user profile associated with the user. Such a technique may enable signaling to other users that are “friends” with or subscribed to the user’s social media account that the user has gone “green” by purchasing and retiring one or more offsetting instruments.

In some embodiments, the processing device may provide, via a user interface on a computing device of the user, a dashboard including one or more graphical elements associated with the REC purchased by the user, one or more graphical elements associated with a carbon footprint offset by the use, or some combination thereof.

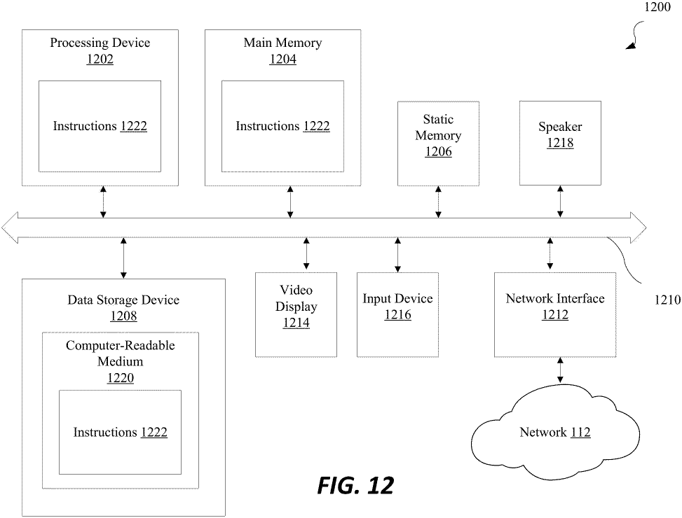

FIG. 12 illustrates an example computer system according to embodiments of this disclosure. In one example, computer system 1200 may include one or more components that correspond to the computing device 102, computing device 108, or computing device 110 of FIG. 1. The computer system 1200 may be connected (e.g., networked) to other computer systems in a LAN, an intranet, an extranet, or the Internet. The computer system 1200 may operate in the capacity of a server in a client-server network environment. The computer system 1200 may be a personal computer (PC), a tablet computer, a laptop, a wearable (e.g., wristband), a set-top box (STB), a personal Digital Assistant (PDA), a smartphone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 1200 includes a processing device 1202, a main memory 1204 (e.g., read-only memory (ROM), solid state drive (SSD), flash memory, dynamic random access memory (DRAM) such as synchronous DRAM (SDRAM)), a static memory 1206 (e.g., solid state drive (SSD), flash memory, static random access memory (SRAM)), and a data storage device 1208, which communicate with each other via a bus 1210.

Processing device 1202 represents one or more general-purpose processing devices such as a microprocessor, central processing unit, or the like. More particularly, the processing device 1202 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1202 may also be one or more special-purpose processing devices such as an application specific integrated circuit (ASIC), a field programmable gate array (FPGA), a digital signal processor (DSP), network processor, or the like. The processing device 1202 is configured to execute instructions for performing any of the operations and steps of any of the methods discussed herein.

The computer system 1200 may further include a network interface device 1212. The computer system 1200 also may include a video display 1214 (e.g., a liquid crystal display (LCD) or a cathode ray tube (CRT)), one or more input devices 1216 (e.g., a keyboard and/or a mouse), and one or more speakers 1218 (e.g., a speaker). In one illustrative example, the video display 1214 and the input device(s) 1216 may be combined into a single component or device (e.g., an LCD touch screen).

The data storage device 1216 may include a computer-readable medium 1220 on which the instructions 1222 embodying any one or more of the methodologies or functions described herein are stored. The instructions 1222 may also reside, completely or at least partially, within the main memory 1204 and/or within the processing device 1202 during execution thereof by the computer system 1200. As such, the main memory 1204 and the processing device 1202 also constitute computer-readable media. The instructions 1222 may further be transmitted or received over the network 112 via the network interface device 1212.

While the computer-readable storage medium 1220 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The various aspects, embodiments, implementations or features of the described embodiments can be used separately or in any combination. The embodiments disclosed herein are modular in nature and can be used in conjunction with or coupled to other embodiments, including both statically-based and dynamically-based equipment. In addition, the embodiments disclosed herein can employ selected equipment such that they can identify individual users and auto-calibrate threshold multiple-of-body-weight targets, as well as other individualized parameters, for individual users.

The foregoing description, for purposes of explanation, used specific nomenclature to provide a thorough understanding of the described embodiments. However, it should be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

### Clauses

1. A computer-implemented method for a processing device executing a gaming management system, wherein the computer-implemented method comprises:
receiving configuration input for a virtual token;
transmitting the configuration input to an energy intelligence platform to cause at least one attribute of the virtual token to be modified;
causing presentation of a storefront application in the gaming management system, wherein at least a purchase option of an offsetting instrument comprising a renewable energy certificate (REC) is presented, and the offsetting instrument is associated with the virtual token;
receiving, from a computing device of a user, a purchase request for the offsetting instrument;
transmitting the purchase request to the energy intelligence platform;
receiving the virtual token from the energy intelligence platform; and
deploying the virtual token during a video game session according to the at least one attribute.

2. The computer-implemented method of any preceding clause, wherein the energy intelligence platform determines a number of offsetting instruments that represent an average of a plurality of users’ carbon footprint offsets of one or more computing devices.

3. The computer-implemented method of any preceding clause, wherein the energy intelligence platform causes the offsetting instruments to be retired for the user and confirms retirement of the offsetting instruments.

4. The computer-implemented method of any preceding clause, wherein the video game session is provided by the gaming management system.

5. The computer-implemented method of any preceding clause, wherein the attribute is associated with an ornamental feature of the virtual token, a functional feature of the virtual token, or some combination thereof.

6. The computer-implemented method of any preceding clause, wherein the energy intelligence platform generates a renewable energy score for the purchase request based on a location of the computing device, historical purchases, time of day energy is used, renewable purchases by location, or some combination thereof.

7. A computer-implemented method for a processing device executing an energy intelligence platform, wherein the computer-implemented method comprises:
receiving, from a gaming management system, configuration input associated with a virtual token;
modifying, based on the configuration input, at least one attribute of the virtual token;
receiving, from the gaming management system, a purchase request for an offsetting instrument comprising a renewable energy certificate (REC);
transmitting the purchase request to an offsetting instrument exchange system;
receiving the offsetting instrument from the offsetting instrument exchange system;
retiring the offsetting instrument in the name of the gaming management system, in the name of a user, or both;
generating the virtual token according to the at least one attribute; and
transmitting the virtual token to the gaming management system, wherein the gaming management system deploys the virtual token during a video game session according to the at least one attribute.

8. The method of any preceding clause, further comprising:
transmitting, to the offsetting instrument exchange system, a request to retire the offsetting instrument; and
receiving a confirmation that the offsetting instrument exchange system has retired the offsetting instrument.

9. The computer-implemented method of any preceding clause, further comprising:
aggregating a plurality of purchase requests;
at a predetermined time, transmitting a bulk purchase request for a plurality of offsetting instruments to the offsetting instrument exchange system; and
receiving the plurality of offsetting instruments.

10. The computer-implemented method of any preceding clause, further comprising:
at a second predetermined time, transmitting a bulk retirement request to the offsetting instrument exchange system to retire the plurality of offsetting instruments; and
receiving an acknowledgement that the plurality of offsetting instruments are retired.

11. The computer-implemented method of any preceding clause, further comprising determining a purchase price of the carbon footprint offset of one or more computing devices of the user.

12. The computer-implemented method of any preceding clause, further comprising:
receiving, from one or more agent applications executing one or more computing devices of users, energy usage information of the one or more computing devices; and
using the energy usage information to determine the purchase price of the virtual token.

13. The computer-implemented method of any preceding clause, wherein the attribute is associated with an ornamental feature of the virtual token, a functional feature of the virtual token, or some combination thereof.

14. The computer-implemented method of any preceding clause, further comprising providing, via an application programming interface, the virtual token to a social media platform to be associated with a user profile of the user.

15. The computer-implemented method of any preceding clause, further comprising providing, via a user interface on a computing device of the user, a dashboard comprising one or more graphical elements associated with the REC purchased by the user, one or more graphical elements associated with a carbon footprint offset by the user, or some combination thereof.

16. The computer-implemented method of any preceding clause, further comprising transferring ownership of the offsetting instrument to an identity of the user.

17. The computer-implemented method of any preceding clause, further comprising modifying a second attribute of the virtual token, wherein the second attribute pertains to a carbon footprint offset of the user of a computing device executing the gaming management system.

18. A system comprising:
a memory device storing instructions; and
a processing device communicatively coupled to the memory device, wherein the processing device is configured to:
receive, from a gaming management system, configuration input associated with a virtual token;
modify, based on the configuration input, at least one attribute of the virtual token;
receive, from the gaming management system, a purchase request for an offsetting instrument comprising a renewable energy certificate (REC) or similarly marketed instruments;
transmit the purchase request to an offsetting instrument exchange system;
receive the offsetting instrument from the offsetting instrument exchange system;
retire the offsetting instrument in the name of the gaming management system, in the name of a user, or both;
generate the virtual token according to the at least one attribute; and
transmit the virtual token to the gaming management system, wherein the gaming management system uses the virtual token during a video game session according to the at least one attribute.

19. The system of any preceding clause, wherein the processing device is further to:
transmit, to the offsetting instrument exchange system, a request to retire the offsetting instrument; and
receive a confirmation that the offsetting instrument exchange system has retired the offsetting instrument.

20. The system of any preceding clause, wherein the processing device is further to:
aggregate a plurality of purchase requests;
at a predetermined time, transmit a bulk purchase request for a plurality of offsetting instruments to the offsetting instrument exchange system; and
receive the plurality of offsetting instruments.

21. The system of any preceding clause, wherein the processing device is further to:
at a second predetermined time, transmit a bulk retirement request to the offsetting instrument exchange system to retire the plurality of offsetting instruments; and
receive an acknowledgement that the plurality of offsetting instruments are retired.

22. The system of any preceding clause, wherein the processing device is further to determine a purchase price of the carbon footprint offset of a computing device of a user of the computing device that transmitted the purchase request.

23. The system of any preceding clause, wherein the processing device is further to:
receive, from one or more agent applications executing one or more computing devices of users, energy usage information of the one or more computing devices; and
use the energy usage information to determine a purchase price of the virtual token.

24. The system of any preceding clause, wherein the attribute is associated with an ornamental feature of the virtual token, a functional feature of the virtual token, or some combination thereof.

25. The system of any preceding clause, wherein the processing device is further to transmit, via an application programming interface, the virtual token to a social media platform to be associated with a user profile of the user.

26. The system of any preceding clause, wherein the offsetting instrument comprises a forestation certificate, a recycling certificate, a green or carbon-capture certificate, or some combination thereof.

What is claimed:

1. A computer-implemented method for a processing device executing a gaming management system, wherein the computer-implemented method comprises:
receiving configuration input for a virtual token;
transmitting the configuration input to an energy intelligence platform to cause at least one attribute of the virtual token to be modified;
causing presentation of a storefront application in the gaming management system, wherein at least a purchase option of an offsetting instrument comprising a renewable energy certificate (REC) is presented, and the offsetting instrument is associated with the virtual token;
receiving, from a computing device of a user, a purchase request for the offsetting instrument;
transmitting the purchase request to the energy intelligence platform;
receiving the virtual token from the energy intelligence platform; and
deploying the virtual token during a video game session according to the at least one attribute.

2. The computer-implemented method of claim 1, wherein the energy intelligence platform determines a number of offsetting instruments that represent an average of a plurality of users’ carbon footprint offsets of one or more computing devices.

3. The computer-implemented method of claim 1, wherein the energy intelligence platform causes the offsetting instruments to be retired for the user and confirms retirement of the offsetting instruments.

4. The computer-implemented method of claim 1, wherein the video game session is provided by the gaming management system.

5. The computer-implemented method of claim 1, wherein the attribute is associated with an ornamental feature of the virtual token, a functional feature of the virtual token, or some combination thereof.

6. The computer-implemented method of claim 1, wherein the energy intelligence platform generates a renewable energy score for the purchase request based on a location of the computing device, historical purchases, time of day energy is used, renewable purchases by location, or some combination thereof.

7. A computer-implemented method for a processing device executing an energy intelligence platform, wherein the computer-implemented method comprises:
receiving, from a gaming management system, configuration input associated with a virtual token;
modifying, based on the configuration input, at least one attribute of the virtual token;
receiving, from the gaming management system, a purchase request for an offsetting instrument comprising a renewable energy certificate (REC);
transmitting the purchase request to an offsetting instrument exchange system;
receiving the offsetting instrument from the offsetting instrument exchange system;
retiring the offsetting instrument in the name of the gaming management system, in the name of a user, or both;
generating the virtual token according to the at least one attribute; and
transmitting the virtual token to the gaming management system, wherein the gaming management system deploys the virtual token during a video game session according to the at least one attribute.

8. The method of claim 7, further comprising:
transmitting, to the offsetting instrument exchange system, a request to retire the offsetting instrument; and
receiving a confirmation that the offsetting instrument exchange system has retired the offsetting instrument.

9. The computer-implemented method of claim 7, further comprising:
aggregating a plurality of purchase requests;
at a predetermined time, transmitting a bulk purchase request for a plurality of offsetting instruments to the offsetting instrument exchange system; and
receiving the plurality of offsetting instruments.

10. The computer-implemented method of claim 9, further comprising:
at a second predetermined time, transmitting a bulk retirement request to the offsetting instrument exchange system to retire the plurality of offsetting instruments; and
receiving an acknowledgement that the plurality of offsetting instruments are retired.

11. The computer-implemented method of claim 7, further comprising determining a purchase price of the carbon footprint offset of one or more computing devices of the user.

12. The computer-implemented method of claim 7, further comprising:
receiving, from one or more agent applications executing one or more computing devices of users, energy usage information of the one or more computing devices; and
using the energy usage information to determine the purchase price of the virtual token.

13. The computer-implemented method of claim 7, wherein the attribute is associated with an ornamental feature of the virtual token, a functional feature of the virtual token, or some combination thereof.

14. The computer-implemented method of claim 7, further comprising providing, via an application programming interface, the virtual token to a social media platform to be associated with a user profile of the user.

15. The computer-implemented method of claim 7, further comprising providing, via a user interface on a computing device of the user, a dashboard comprising one or more graphical elements associated with the REC purchased by the user, one or more graphical elements associated with a carbon footprint offset by the user, or some combination thereof.

16. The computer-implemented method of claim 7, further comprising transferring ownership of the offsetting instrument to an identity of the user.

17. The computer-implemented method of claim 7, further comprising modifying a second attribute of the virtual token, wherein the second attribute pertains to a carbon footprint offset of the user of a computing device executing the gaming management system.

18. A system comprising:
a memory device storing instructions; and
a processing device communicatively coupled to the memory device, wherein the processing device is configured to:
receive, from a gaming management system, configuration input associated with a virtual token;
modify, based on the configuration input, at least one attribute of the virtual token;
receive, from the gaming management system, a purchase request for an offsetting instrument comprising a renewable energy certificate (REC) or similarly marketed instruments;
transmit the purchase request to an offsetting instrument exchange system;
receive the offsetting instrument from the offsetting instrument exchange system;
retire the offsetting instrument in the name of the gaming management system, in the name of a user, or both;
generate the virtual token according to the at least one attribute; and
transmit the virtual token to the gaming management system, wherein the gaming management system uses the virtual token during a video game session according to the at least one attribute.

19. The system of claim 18, wherein the processing device is further to:
transmit, to the offsetting instrument exchange system, a request to retire the offsetting instrument; and
receive a confirmation that the offsetting instrument exchange system has retired the offsetting instrument.

20. The system of claim 18, wherein the processing device is further to:
aggregate a plurality of purchase requests;
at a predetermined time, transmit a bulk purchase request for a plurality of offsetting instruments to the offsetting instrument exchange system; and
receive the plurality of offsetting instruments.
